(19) United States
(12) Patent Application Publication
(10) Pub. No.: US 2008/0151572 A1
(43) Pub. Date: Jun. 26, 2008

(54) Light guide plate with light diffusing structure, backlight module and liquid crystal display using same

(75) Inventor: Xiao-Ping Ma, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/004,887

(22) Filed: Dec. 21, 2007

(30) Foreign Application Priority Data
Dec. 22, 2006 (CN) 200610157872.4

(51) Int. Cl. F21V 7/04

(52) U.S. Cl. 362/609

(57) ABSTRACT

An exemplary light guide plate (21) includes a main body (25) and a protrusion (26). The main body includes a plurality of side surfaces. At least one of the side surfaces is a reflective side surface. The protrusion extends from one of the side surfaces. The protrusion includes a light incident side surface (261) and a reflective side surface (263). The main body defines a light emitting area (27). Incident light beams emitted from the light incident side surface of the protrusion are reflected by the reflective side surfaces of the main body and the protrusion once or more than once. Thereby, the reflective light beams have a divergence angle larger than a divergence angle of the incident light beams. The reflective light beams are transmitted to the light emitting area of the main body and are converted into flat light therein.

### FIELD OF THE INVENTION

The present invention relates to a light guide plate with light diffusing structure. The present invention also relates to a backlight module and a liquid crystal display using the light guide plate.

### GENERAL BACKGROUND

Liquid crystal of a liquid crystal display (LCD) does no itself emit light. Therefore it is common for a backlight module to be installed in an LCD together with the LCD. The backlight module provides uniform flat light to enable the LCD to display images.

FIG. 7 is a top plan view of certain components of a conventional backlight module. The backlight module 1 includes a light guide plate (LGP) 13 and four light emitting diodes (LEDs) 12. The LGP 13 includes a side surface 131 for receiving incident light, and a top surface 133 for emitting flat light. The top surface 133 is generally perpendicularly connected with the side surface 131. The LEDs 12 are disposed adjacent to the side surface 131 of the LGP 13.

In operation, light beams emitted by the LEDs 12 enter into the LGP 13 via the side surface 131 thereof. Then, the light beams are converted into flat light by the LGP 13 and then emit from the top surface 133 of the LGP 13. However, the light beams emitted by each of the LEDs 12 have a divergence angle. That is, areas 15 of the top surface 133 that beyond the divergence angles of the LEDs 12 may be relative dark areas. Therefore, the flat light emitted from the top surface 133 of the LGP 13 may be non-uniform. As a result, the performance of an associated LCD may be visibly impaired.

What is needed, therefore, is a light guide plate and an associated backlight module and liquid crystal display that can overcome the above-described deficiencies.

### SUMMARY

A light guide plate includes a main body and a protrusion. The main body includes a plurality of side surfaces. At least one of the side surfaces is a reflective side surface. The protrusion extends from one of the side surfaces. The protrusion includes a light incident side surface and a reflective side surface connected with the at least one reflective side surface of the main body. The main body defines a light emitting area. Incident light beams emitted from the light incident side surface of the protrusion are reflected by the reflective side surfaces of the main body and the protrusion once or more than once. Thereby, the reflective light beams have a divergence angle larger than a divergence angle of the incident light beams. The reflective light beams are transmitted to the light emitting area of the main body and are converted into flat light therein.

A backlight module includes a light source and a light guide plate. The light guide plate includes a main body and a protrusion. The main body includes a plurality of side surfaces. At least one of the side surfaces is a reflective side surface. The protrusion extends from one of the side surfaces. The protrusion includes a light incident side surface and a reflective side surface connected with the at least one reflective side surface of the main body. The main body defines a light emitting area. Incident light beams emitted from the light incident side surface of the protrusion are reflected by the reflective side surfaces of the main body and the protrusion once or more than once. Thereby, the reflective light beams have a divergence angle larger than a divergence angle of the incident light beams. The reflective light beams are transmitted to the light emitting area of the main body and are converted into flat light therein.

A liquid crystal display includes a liquid crystal display panel, a light source, and a light guide plate. The light guide plate includes a main body and a protrusion. The main body includes a plurality of side surfaces. At least one of the side surfaces is a reflective side surface. The protrusion extends from one of the side surfaces. The protrusion includes a light incident side surface and a reflective side surface connected with the at least one reflective side surface of the main body. The main body defines a light emitting area. Incident light beams emitted from the light incident side surface of the protrusion are reflected by the reflective side surfaces of the main body and the protrusion once or more than once. Thereby, the reflective light beams have a divergence angle larger than a divergence angle of the incident light beams. The reflective light beams are transmitted to the light emitting area of the main body and are converted into flat light therein.

Other novel features and advantages will become more apparent from the following detailed description when taken in conjunction with the accompanying drawings.

### BRIEF DESCRIPTION OF THE DRAWINGS

FIG. 1 is an isometric, exploded view of an LCD according to a first embodiment of the present invention, the LCD including a light guide plate.

FIG. 2 is an essential optical paths diagram of the light guide plate of the LCD of FIG. 1.

FIG. 3 is a top plan view of an LGP of an LCD according to a second embodiment of the present invention.

FIG. 4 is a top plan view of an LGP of an LCD according to a third embodiment of the present invention.

FIG. 5 is a top plan view of an LGP of an LCD according to a fourth embodiment of the present invention.

FIG. 6 is a top plan view of an LGP of an LCD according to a fifth embodiment of the present invention.

FIG. 7 is a top plan view of certain components of a conventional backlight module.

### DETAILED DESCRIPTION OF PREFERRED EMBODIMENTS

Reference will now be made to the drawings to describe the preferred and exemplary embodiments in detail.

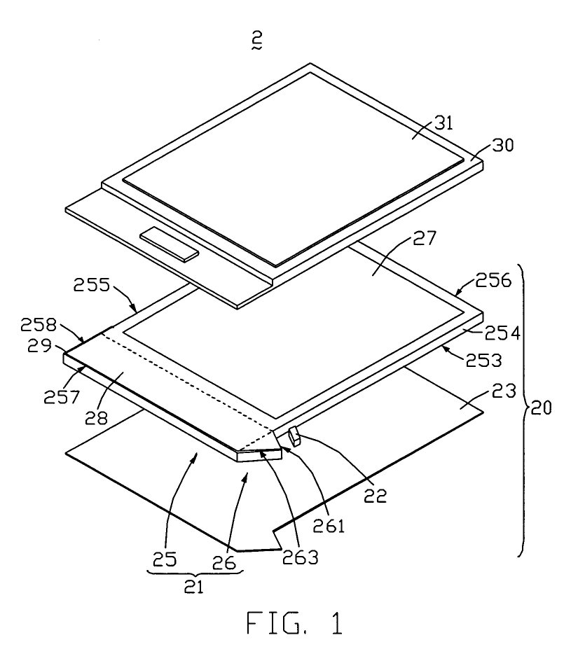

FIG. 1 is an isometric, exploded view of an LCD 2 according to a first embodiment of the present invention. The LCD 2 includes a liquid crystal panel 30 and a backlight module 20 disposed under the liquid crystal display panel 30. The backlight module 20 provides flat and uniform light for illuminating the liquid crystal display panel 30. The liquid crystal panel 30 defines a display area 31 for displaying images and a non-display area (not labeled) for bonding drive circuits (not labeled).

The backlight module 20 includes an LGP 21, a light source 22, and a reflector 23. The reflector 23 is disposed under the LGP 21. In the illustrated embodiment, the light source 22 is an LED.

The LGP 21 includes a main body 25 and a protrusion 26 extending from the main body 25. The protrusion 26 has a thickness the same as the main body 25 and is substantially coplanar with the main body 25.

The main body 25 has a rectangular shape and includes a top surface (not labeled), a bottom surface 253, a first side surface 254, a second side surface 255 opposite to the first side surface 254, a third side surface 256, a fourth side surface 257 opposite to the third side surface 256. The first, second, third, and fourth side surfaces 254, 255, 256, 257 of the main body 25 are joined end to end.

The top surface of the main body 25 defines a light emitting area 27 corresponding to the display area 31 of the liquid crystal panel 30 and a light diffusing area 28 corresponding to the non-display area of the liquid crystal panel 30. Part of the bottom surface 253 that corresponding to the light emitting area 27 of the top surface includes a plurality of scattering-dots (not shown) thereon. The scattering-dots are arranged in a special pattern to enable the light emitting area 27 to emit uniform light.

The protrusion 26 extends from part of the first side surface 254 that corresponding to the light diffusing area 28 of the top surface. The protrusion 26 has a triangular shape. Thereby, the protrusion 26 includes a fifth side surface 261 and a sixth side surface 263. The fifth side surface 261 is used as a light incident surface. The light source 22 is disposed adjacent to the fifth side surface 261 of the protrusion 26.

The fifth and sixth side surfaces 261, 263 maintain a first crossing angle varied in the range from 50 degrees to 80 degrees. The fifth side surface 261 is connected to the first side surface 254 of the main body 25. The first and fifth side surfaces 254, 261 maintain a second crossing angle varied in the range from 110 degrees to 130 degrees. The sixth side surface 263 is connected to the fourth side surface 257 of the main body 25. The fourth and sixth side surfaces 257, 263 maintain a third crossing angle varied in the range from 110 degrees to 130 degrees.

A reflective layer 29 covers the sixth side surface 263 of the protrusion 26, the fourth side surface 257, and a reflective area 258 the second side surface 255 that corresponding to the light diffusing area 28 of the top surface. Therefore, the reflective layer 29 and corresponding portion of the LGP 21 define a light diffusing structure (not labeled) for diffusing incident light. The reflective layer 29 may be formed by coating reflective material on the fourth side surface 257, the sixth side surface 263, and the reflective area 258 of the second side surface 255.

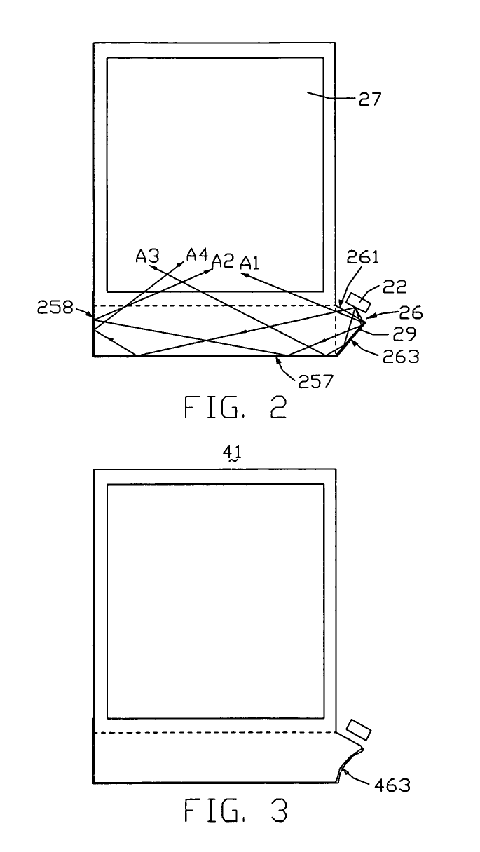

Referring also to FIG. 2, this is an essential optical paths diagram of the LGP 21 of the LCD 2. Light beams emitted by the light source 22 enter into the LGP 21 via the fifth side surface 261 of the protrusion 26. Then, the light beams are diffused by the light diffusing structure. Take light beams A1, A2, A3, A4 emitted from the light source 22 as examples. The light beams A1 are directly reflected by the sixth side surface 263 of the protrusion 26 into the light emitting area 27 of the main body 25. The light beams A3 are firstly reflected by the sixth side surface 263 of the protrusion 26, and then are reflected by the fourth side surface 257 into the light emitting area 27 of the main body 25.

Similarly, the light beams A2 are firstly reflected by the sixth side surface 263 of the protrusion 26, and then are reflected by the fourth side surface 257. The light beams A2 are transmitted to the reflective area 258 of the second side surface 255, and then are reflected into the light emitting area 27 of the main body 25. The light beams A4 are firstly reflected by the fourth side surface 257, and then are reflected by the reflective area 258 of the second side surface 255 into the light emitting area 27 of the main body 25.

The LGP 21 includes the protrusion 26 extending from the main body 25 and the diffusing structure for diffusing incident light beams. The transmitting directions of the incident light beams are changed by the diffusing structure. Therefore, the light beams diffused by the diffusing structure may have a divergence angle larger than a divergence angle of the light source 22. As a result, the light beams emitted from the light emitting area 27 of the LGP 21 are more uniform. The LCD 2 employing the LGP 21 exhibits good display characteristics.

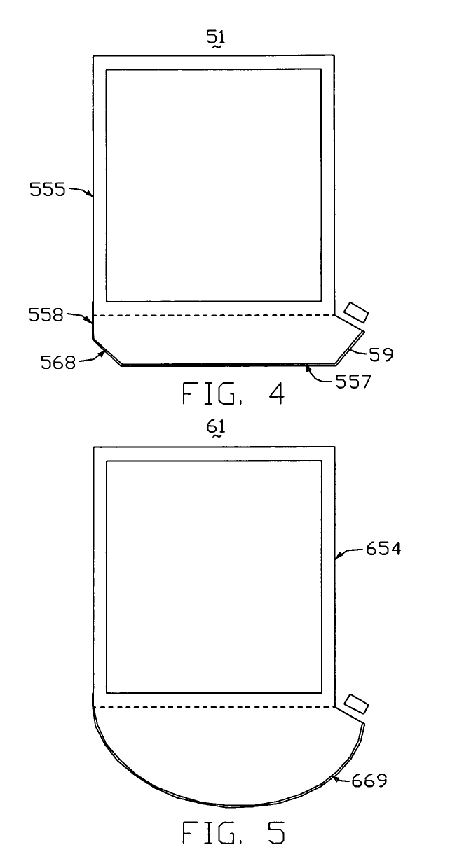

FIG. 3 is a top plan view of an LGP 41 of an LCD according to a second embodiment of the present invention. The LGP 41 has a structure similar to that of the LGP 21. However, a sixth side surface 463 is a concave surface.

FIG. 4 is a top plan view of an LGP 51 of an LCD according to a third embodiment of the present invention. The LGP 51 has a structure similar to that of the LGP 21. However, the LGP 51 includes a cut angle (not labeled) between a second side surface 555 and a fourth side surface 557. The cut angle defines a seventh side surface 568. The seventh side surface 568 and the second side surface 555 maintain a fourth crossing angle varied in the range from 120 degrees to 150 degrees. The seventh side surface 568 and the fourth side surface 557 maintain a fifth crossing angle varied in the range from 120 degrees to 150 degrees. A reflector layer 59 covers the seventh side surface 568, the fourth side surface 557, a sixth side surface (not labeled), and a reflective area 558 of the second side surface 555.

The LGP 51 includes the seventh side surfaces 568 located in a direction different from the second and fourth side surfaces 555, 557. Therefore, incident light beams may be further reflected by the seventh side surfaces 568. As a result, the diffused light beams may have a larger divergence angle. That is, the light beams emitted from the LGP 51 are more uniform.

FIG. 5 is a top plan view of an LGP 61 of an LCD according to a fourth embodiment of the present invention. The LGP 61 has a structure similar to that of the LGP 21. However, a main body (not labeled) and a protrusion (not labeled) of the LGP 61 define a smooth curved surface 669 protruded in a direction of a first side surface 654.

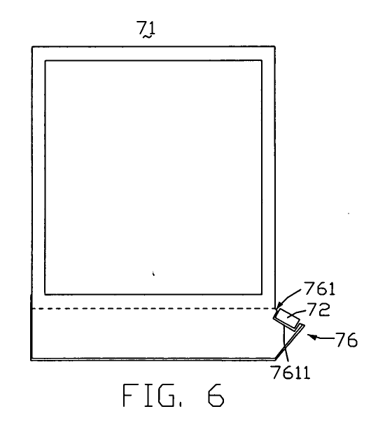

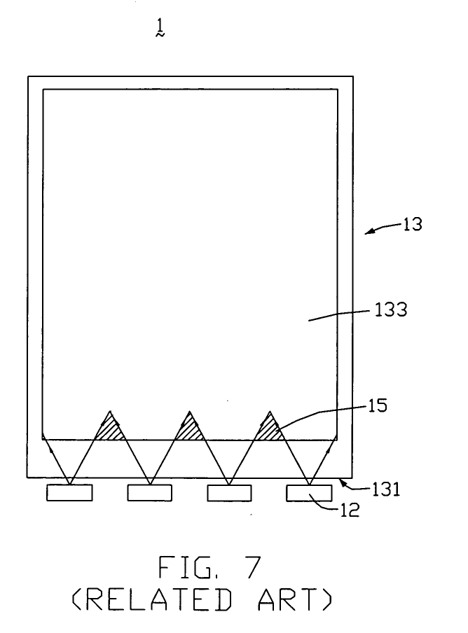

FIG. 6 is a top plan view of an LGP 71 of an LCD according to a fifth embodiment of the present invention. The LGP 71 has a structure similar to that of the LGP 21. However, a fifth side surface 761 of a protrusion 76 includes a rectangular notch 7611. A light source 72 is located in the notch 7611. A backlight module employing the LGP 71 takes up smaller space.

Various modifications and alterations to the above-described embodiments are possible. For example, the notch 7611 of the fifth side surface 761 of the protrusion 76 may have other shape such as semicircular shape.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light guide plate, comprising:
a main body comprising a plurality of side surfaces, at least one of the side surfaces being a reflective side surface;
a protrusion extending from one of the side surfaces, the protrusion comprising a light incident side surface and a reflective side surface connected with the at least one reflective side surface of the main body;
wherein the main body defines a light emitting area, incident light beams emitted from the light incident side surface of the protrusion are reflected by the reflective side surfaces of the main body and the protrusion once or more than once, thereby the reflective light beams have a divergence angle larger than a divergence angle of the incident light beams, the reflective light beams are transmitted to the light emitting area of the main body and are converted into flat light therein.

2. The light guide plate as claimed in claim 1, wherein the protrusion has a triangular shape.

3. The light guide plate as claimed in claim 2, wherein the light incident side surface and the reflective side surface of the protrusion maintain an angle varied in the range from 50 degrees to 80 degrees

4. The light guide plate as claimed in claim 2, wherein the main body includes a first side surface, a second side surface opposite to the first side surface, a third side surface, and a fourth side surface opposite to the third side surface, the first, second, third, and fourth side surfaces of the main body are joined end to end.

5. The light guide plate as claimed in claim 4, wherein the protrusion extends from the first side surface of the main body.

6. The light guide plate as claimed in claim 5, wherein the light incident side surface of the protrusion is connected to the first side surface of the main body, the reflective side surface of the protrusion is connected to the fourth side surface of the main body.

7. The light guide plate as claimed in claim 6, wherein the light incident side surface of the protrusion together with the first side surface of the main body maintains an angle varied in the range from 110 degrees to 130 degrees.

8. The light guide plate as claimed in claim 6, wherein the reflective side surface of the protrusion together with the fourth side surface of the main body maintains an angle varied in the range from 110 degrees to 130 degrees.

9. The light guide plate as claimed in claim 6, wherein the second side surface of the main body defines a reflective area connected with the fourth side surface of the main body.

10. The light guide plate as claimed in claim 9, wherein the reflective side surface of the protrusion, the fourth side surface of the main body, and the reflective area of the second side surface of the main body are covered by a reflective layer.

11. The light guide plate as claimed in claim 2, wherein the reflective side surface of the protrusion is a concave surface.

12. The light guide plate as claimed in claim 4, wherein the main body further comprises a cut angle, the cut angle defines a fifth side surface connected with the second side surface and the fourth side surface, respectively.

13. The light guide plate as claimed in claim 12, wherein the fifth and second side surfaces of the main body maintain an angle varied in the range from 120 degrees to 150 degrees.

14. The light guide plate as claimed in claim 12, wherein the fifth and fourth side surfaces maintain an angle varied in the range from 120 degrees to 150 degrees.

15. The light guide plate as claimed in claim 1, wherein the protrusion has a thickness the same as the main body and is coplanar with the main body.

16. The light guide plate as claimed in claim 1, wherein the reflective side surfaces of the main body and the protrusion define a smooth curved side surface.

17. The light guide plate as claimed in claim 1, wherein the light incident side surface of the protrusion comprises a notch for receiving a light source.

18. The light guide plate as claimed in claim 17, wherein the notch has a rectangular shape.

19. A backlight module, comprising:
a light source; and
a light guide plate, the light guide plate comprising:
a main body comprising a plurality of side surfaces, at least one of the side surfaces being a reflective side surface;
a protrusion extending from one of the side surfaces, the protrusion comprising a light incident side surface and a reflective side surface connected with the at least one reflective side surface of the main body;
wherein the main body defines a light emitting area, incident light beams emitted from the light source are reflected by the reflective side surfaces of the main body and the protrusion once or more than once, thereby the reflective light beams have a divergence angle larger than a divergence angle of the incident light beams, the reflective light beams are transmitted to the light emitting area of the main body and are converted into flat light therein.

20. A liquid crystal display, comprising:
a liquid crystal display panel;
a light source; and
a light guide plate, the light guide plate comprising:
a main body comprising a plurality of side surfaces, at least one of the side surfaces being a reflective side surface;
a protrusion extending from one of the side surfaces, the protrusion comprising a light incident side surface and a reflective side surface connected with the at least one reflective side surface of the main body;
wherein the main body defines a light emitting area, incident light beams emitted from the light source are reflected by the reflective side surfaces of the main body and the protrusion once or more than once, thereby the reflective light beams have a divergence angle larger than a divergence angle of the incident light beams, the reflective light beams are transmitted to the light emitting area of the main body and are converted into flat light therein.
